(19) United States
(12) Patent Application Publication
(10) Pub. No.: US 2025/0203351 A1
(43) Pub. Date: Jun. 19, 2025

(54) MESSAGING IN WI-FI NETWORKS

(71) Applicant: Charter Communications Operating, LLC, St. Louis, MO (US)

(72) Inventor: William Herrera, Garland, TX (US)

(21) Appl. No.: 18/389,673

(22) Filed: Dec. 19, 2023

(51) Int. Cl. H04W 12/02; H04W 4/12; H04W 12/63; H04W 84/12

(52) U.S. Cl. CPC H04W 12/02; H04W 4/12; H04W 12/63; H04W 84/12

(57) ABSTRACT

Make available, to a plurality of administrators of a plurality of wireless local area networks, a portal that permits specification of messages to be displayed to potential users of the wireless local area networks. Obtain, by a wide area network operator, via the portal, a plurality of messages associated with the plurality of wireless local area networks, to be provided to putative users of the plurality of wireless local area networks. Selectively provide (i.e., from the wide area network operator) at least a subset of the plurality of messages to corresponding ones of the putative users.

### FIELD OF THE INVENTION

The present invention relates generally to the electrical, electronic and computer arts, and, more particularly, to networking and content management.

### BACKGROUND OF THE INVENTION

With the proliferation of smartphones and the constant need for internet connectivity, Wi-Fi networks have become a ubiquitous part of daily life. Wi-Fi networks are typically configured to provide Internet connectivity for connected users in a small geographical area, such as in a mall, an airport, an office building, and the like. The Wi-Fi networks can be discovered via applications on the user's portable client device, such as a smartphone or laptop computer, and often require a registration process to be completed before data can be accessed via the Wi-Fi network. A Wi-Fi finder is a software application capable of identifying and analyzing Wi-Fi networks, which are based on the IEEE 802.11 standards.

Currently, when accessing a Wi-Fi network, the user typically is greeted with a so-called splash screen or splash page, which may provide, for example, a welcome message and instructions for log-in. The administrator of a Wi-Fi network can typically log in to a web-based interface (which may be referred to as a portal) and specify who is to be allowed/blocked. Personalization and engagement are typically lacking in current messaging within Wi-Fi networks.

It is worth noting that an ad portal is software that prompts a user through the creation of a simple television ad.

### SUMMARY OF THE INVENTION

Principles of the invention provide techniques for messaging in Wi-Fi networks. In one aspect, an exemplary method includes the operations of making available, to a plurality of administrators of a plurality of wireless local area networks, a portal that permits specification of messages to be displayed to potential users of the wireless local area networks; obtaining, by a wide area network operator, via the portal, a plurality of messages associated with the plurality of wireless local area networks, to be provided to putative users of the plurality of wireless local area networks; and selectively providing at least a subset of the plurality of messages to corresponding ones of the putative users.

In another aspect, a non-transitory computer readable medium includes computer executable instructions which when executed by a computer cause the computer to perform a method including: making available, to a plurality of administrators of a plurality of wireless local area networks, a portal that permits specification of messages to be displayed to potential users of the wireless local area networks; obtaining, by a wide area network operator, via the portal, a plurality of messages associated with the plurality of wireless local area networks, to be provided to putative users of the plurality of wireless local area networks; and selectively providing at least a subset of the plurality of messages to corresponding ones of the putative users.

In still another aspect, a messaging portal includes a memory; and at least one processor, coupled to the memory, and operative to: make available, to a plurality of administrators of a plurality of wireless local area networks, access to the portal to permit specification of messages to be displayed to potential users of the wireless local area networks; obtain, by a wide area network operator, via the portal, a plurality of messages associated with the plurality of wireless local area networks, to be provided to putative users of the plurality of wireless local area networks; and selectively provide at least a subset of the plurality of messages to corresponding ones of the putative users.

In a further aspect, a messaging portal includes at least one server hosting a database; at least one application programming interface; and at least one network interface coupled to the server. The at least one application programming interface provides a plurality of administrators of a plurality of wireless local area networks access to the database to permit specification of messages to be loaded into the database for display to potential users of the wireless local area networks. The database stores the plurality of messages. The at least one server selectively provides at least a subset of the plurality of messages to corresponding ones of the putative users via the network interface.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of a system, such as a messaging portal, which can also be thought of as an engagement portal that facilitates messaging, including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
Wi-Fi network systems configured to embed content into the network traffic being transported by the Wi-Fi network;
a user-friendly engagement portal and management user interface (UI) configured to enable Wi-Fi managers and administrators to seamlessly post messages such as emergency notices, advertisements, promotional offers, and the like directly to users within the Wi-Fi network;
a dedicated mobile application that empowers users to discover Wi-Fi networks and access content residing in or accessible to the Wi-Fi network;
mechanisms that enhance the way Wi-Fi owners interact with the network users and the wider public;
a system that enables Wi-Fi owners and their permitted third parties to create, manage, and optimize messaging campaigns with precision, linking, for example, to a content delivery network (including, e.g., frontend and backend servers);
a notifications system that sends push notifications to users for personalized messages, which increases the chances of user engagement with messages;
A Wi-Fi messaging portal and personalized dashboard to create and manage messages;
Techniques wherein users and/or Wi-Fi networks are enabled to reach the frontend and/or backend servers through the internet for access to messaging content;
a location based services (LBS) and integrated beacon technology to deliver targeted messages based on the user's location, and/or to enhance the relevance of messages, specifically for business/Wi-Fi networks within proximity of the user;
Integration with beacon devices, using Bluetooth Low Energy (BLE) or the like for proximity detection;
User authentication and authorization using secure authentication methods (e.g., OAuth, JWT (JSON Web Tokens) and role-base access controls such as Role-based access control (RBAC) and/or service set identifier (SSID));
Data encryption implementing SSL/TLS protocols to encrypt data in transit;
Database management of user profiles, message content, and campaign data, using relational or NoSQL databases to ensure integrity and indexing;
Message content management-handle storage, retrieval, and management of messages-using a content delivery network of a provider for media assets, optimization of images, and/or video compression;
Messaging campaign management enabling the Wi-Fi owners/third party permitted parties to set up and monitor messaging campaigns-implementing a user-friendly dashboard and integrating with messaging inventory management systems server/databases;
APIs and data exchange enabling communication between frontend and backend components, by implementing RESTful APIs, using standardized data exchange formats (e.g., JavaScript Object Notation (JSON)).

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 illustrates a client device, such as a smartphone, configured to connect with Wi-Fi networks, in accordance with example embodiments;

FIG. 11 illustrates a Wi-Fi system, in the context of a larger network architecture, in accordance with example embodiments;

FIG. 12 illustrates example windows of a graphical user interface (GUI) for viewing messages such as advertisements, deals, news, and notifications on a client device, in accordance with example embodiments;

FIG. 13 illustrates further example windows of a GUI for viewing messages such as advertisements, deals, news and notifications on a client device, in accordance with example embodiments;

FIG. 14 illustrates still further example windows of a GUI for viewing messages such as advertisements, deals, news and notifications on a client device, in accordance with example embodiments;

FIG. 15 illustrates an example GUI for using augmented reality in conjunction with the Wi-Fi system, in accordance with example embodiments;

FIG. 16 shows a messaging portal platform data flow diagram, in accordance with an exemplary embodiment;

FIG. 17 shows a detailed messaging portal platform data flow diagram, in accordance with an exemplary embodiment; and

FIG. 18 is a block diagram of an exemplary cellular phone or the like, which can execute an “app” according to an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

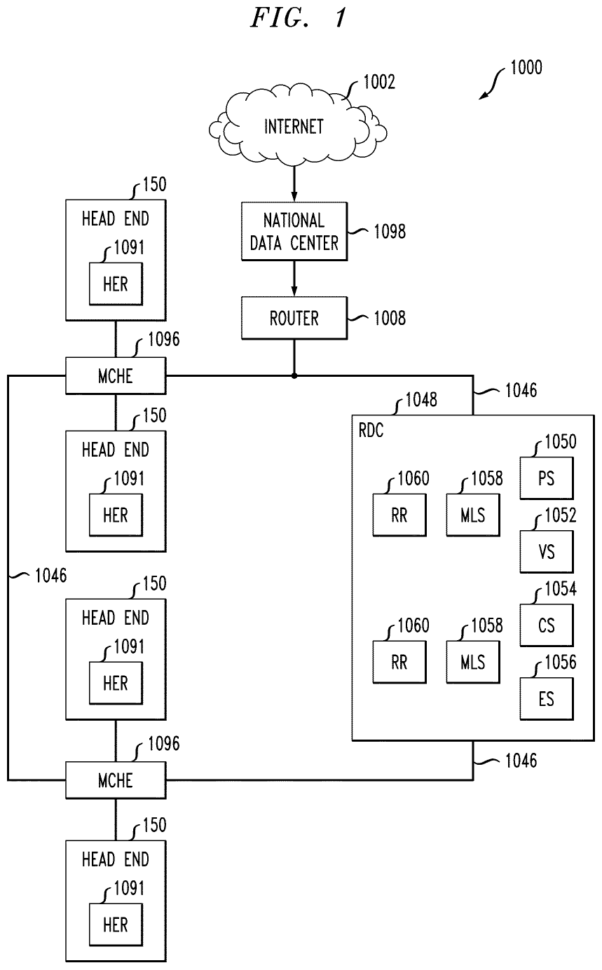

Purely by way of example and not limitation, some embodiments will be shown in the context of a cable multi-service operator (MSO) providing data services as well as entertainment services. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

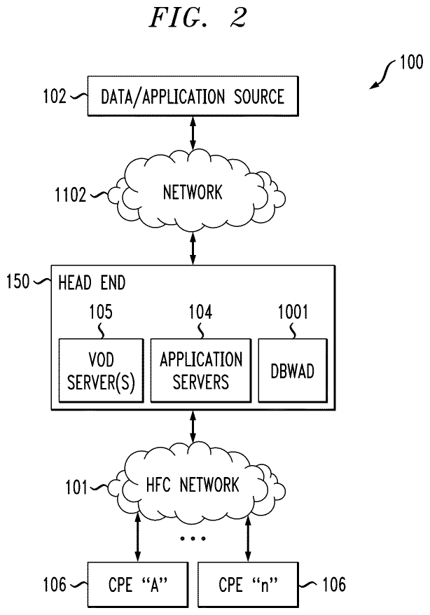

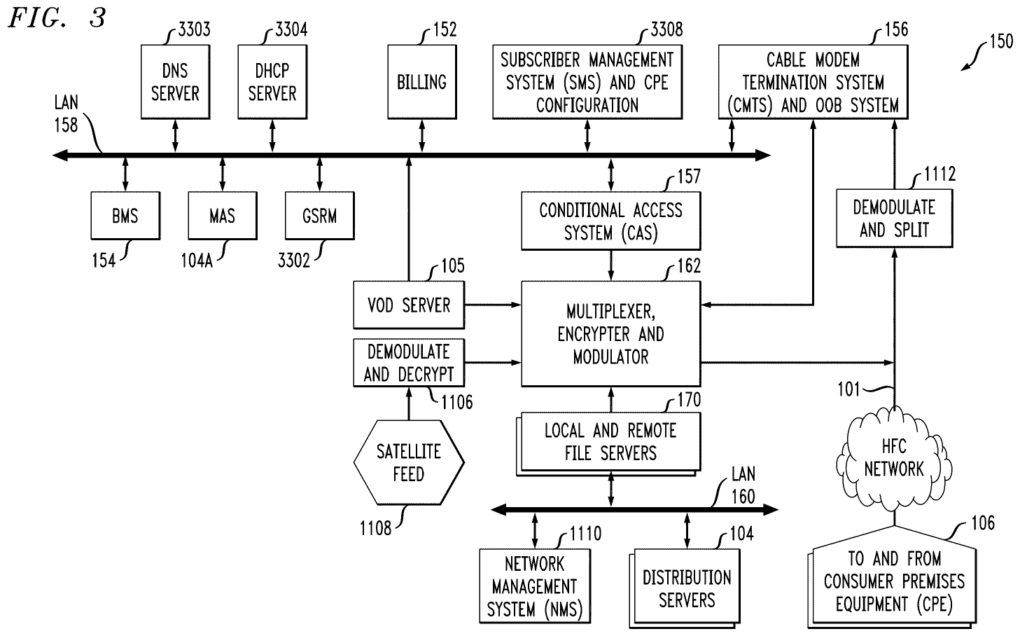

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

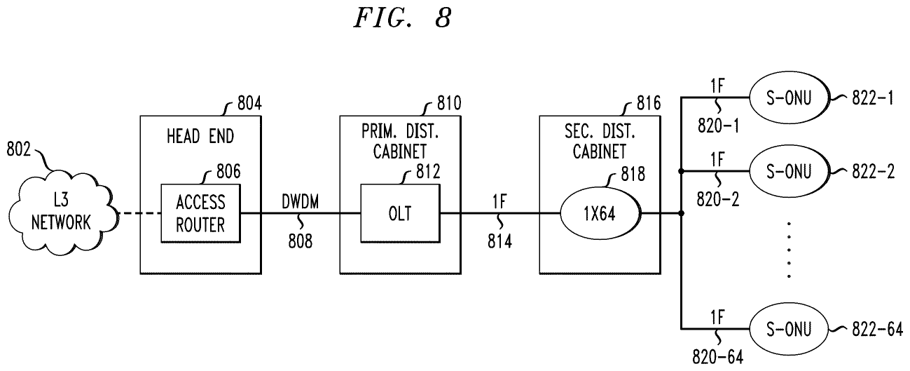

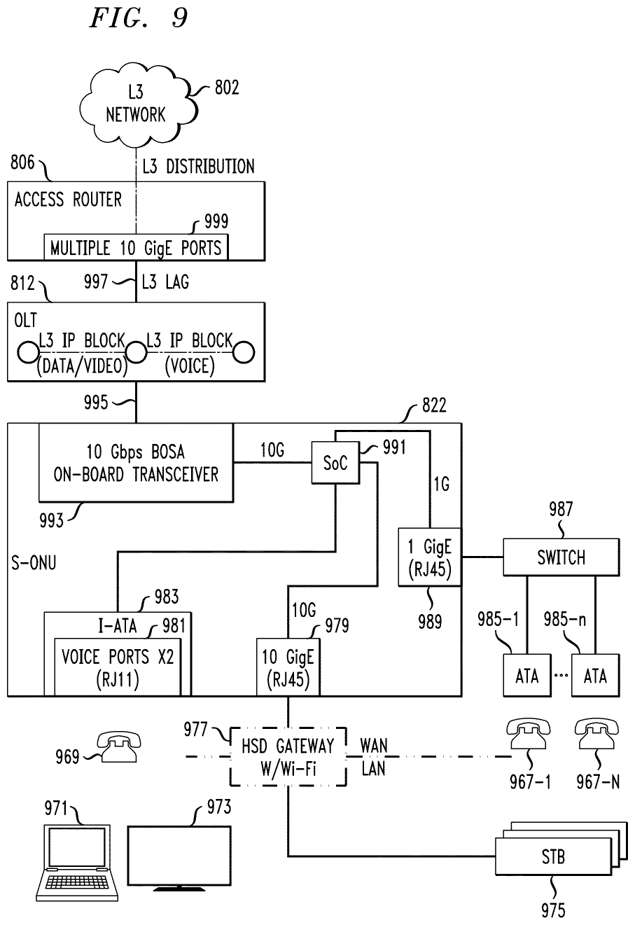

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

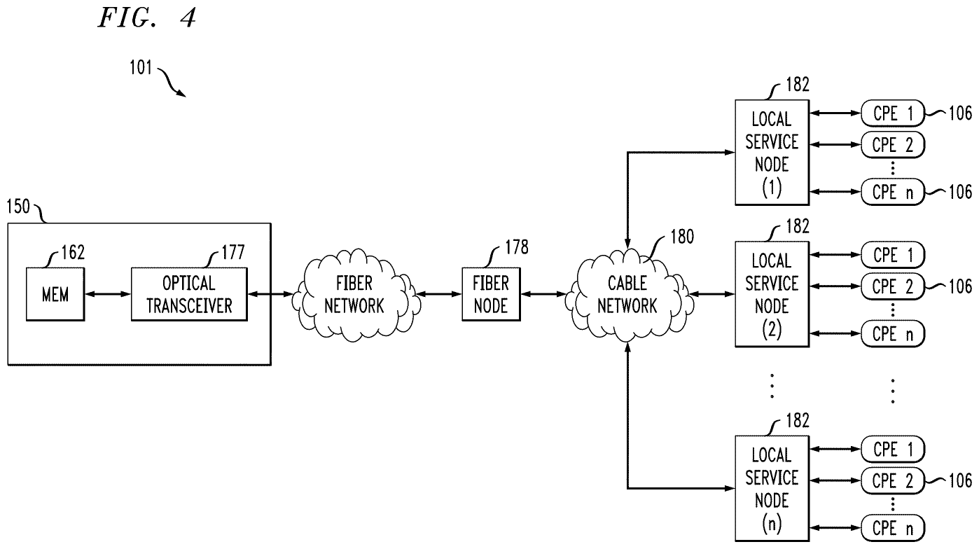

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

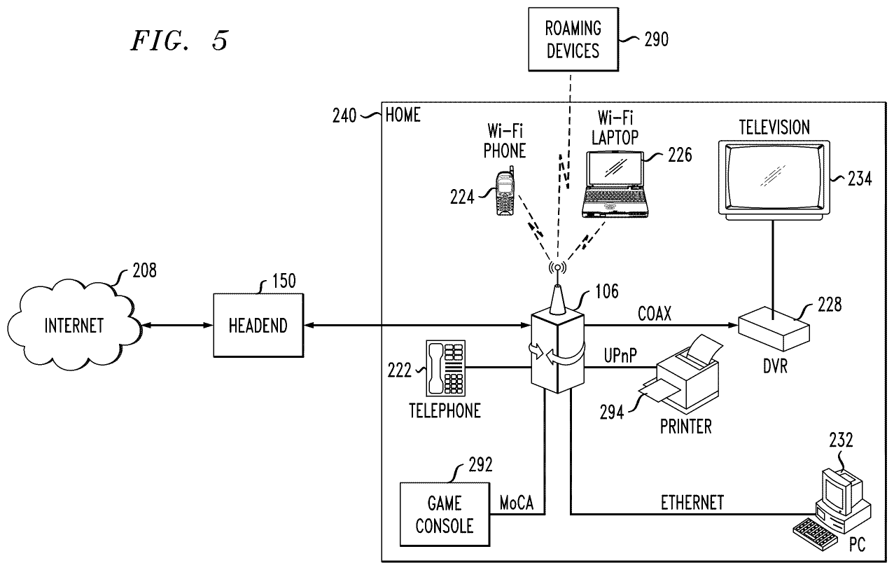

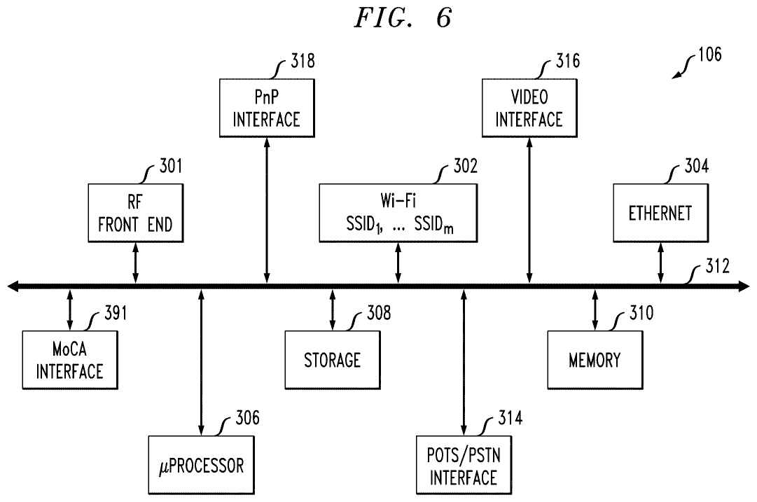

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip”(SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for messaging in Wi-Fi networks. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Generally, methods and systems for locally distributing messages/content, such as advertisements, emergency messages, notices, and the like via a Wi-Fi network are disclosed. In one example embodiment, the content is incorporated onto the traffic flows being transported by the Wi-Fi network. In one example embodiment, the content is provided to an application or other type of interface (e.g., browser) of a client device via the Wi-Fi network. One or more embodiments provide a Wi-Fi platform that includes portal and management graphical user interfaces (GUIs), implemented as add-on features for Wi-Fi networks, and enhancing the way Wi-Fi owners and managers interact with network users and the wider public. By providing a user-friendly portal and management UI, an exemplary Wi-Fi platform enables Wi-Fi managers to seamlessly post messages/content such as emergency messages, notices, advertisements (ads), promotional offers and the like directly to users on their Wi-Fi networks, providing security and emergency management, enhancing communication, and the like. Additionally, in one or more embodiments, a dedicated mobile application empowers users to discover available Wi-Fi networks and access messages/content such as emergency messages, notices, exclusive deals and advertisements, and the like. In some instances, the app includes a dedicated section to locate pertinent messages such as exclusive promotions.

An exemplary Wi-Fi system addresses the untapped potential of Wi-Fi networks as a valuable messaging/notification medium. With the proliferation of smartphones and the constant need for internet connectivity, Wi-Fi networks have become a ubiquitous part of daily life. One or more embodiments advantageously offer a comprehensive platform that connects Wi-Fi owners, network users, and businesses through targeted notice and content distribution. In addition to message distribution, one or more embodiments increase user engagement, deliver targeted ad content, and provide insightful data to third party messages and Wi-Fi network managers. One or more embodiments advantageously integrate a user-friendly mobile application, cutting-edge server infrastructure, a Wi-Fi content management portal and innovative messaging content management. In one or more embodiments, messages are delivered through an “app” using innovative techniques, including augmented reality (AR) and interactive messaging content.

One or more embodiments advantageously include an intuitive interface to create and manage emergency notifications and messaging campaigns, and to distribute messages issued by third-parties. Targeting options for messages may be based on demographics, interests, behavior and the like. Detailed analytics for messaging campaign evaluation and optimization are also included in one or more embodiments. In one example embodiment, advanced scheduling options for messaging campaigns are provided, allowing Wi-Fi owners and managers to target specific days, times, seasons, and the like. A dedicated dashboard for Wi-Fi owners and managers enables the management of their messaging campaigns and the creation of notices and messages. In one or more embodiments, an exemplary Wi-Fi system enables private in-network messages and public messages for users of the Wi-Fi network.

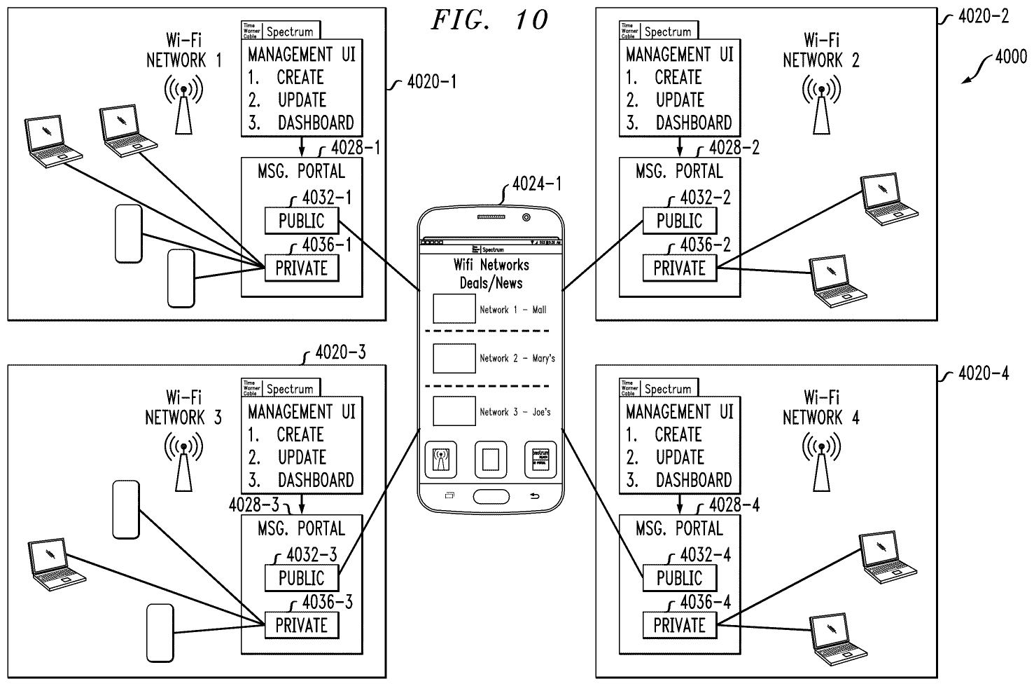

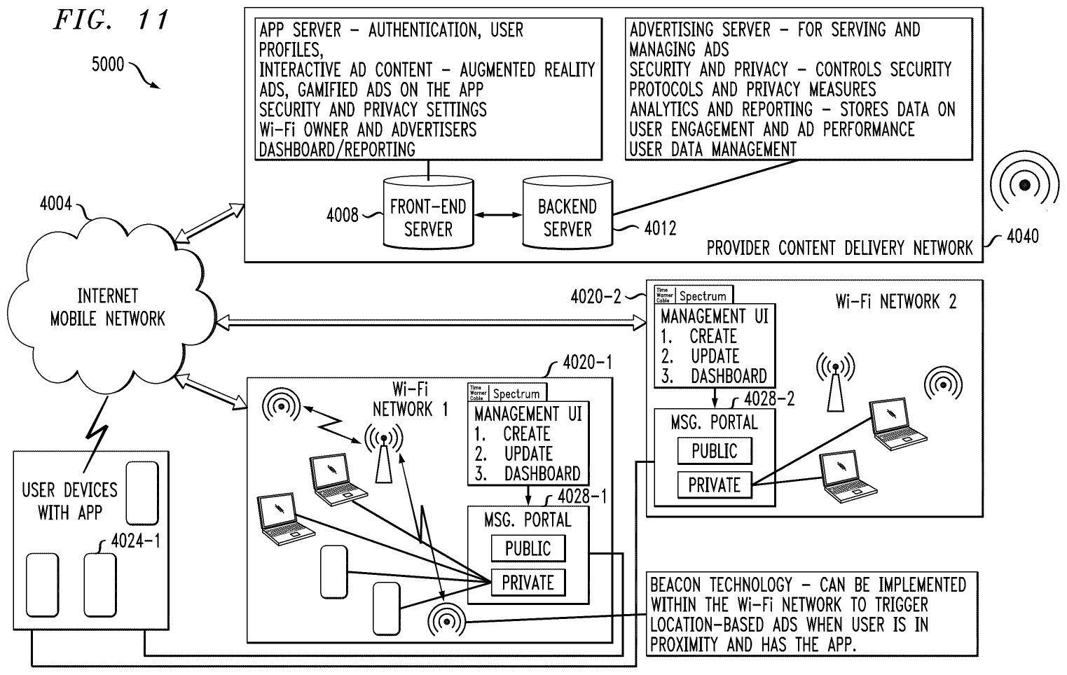

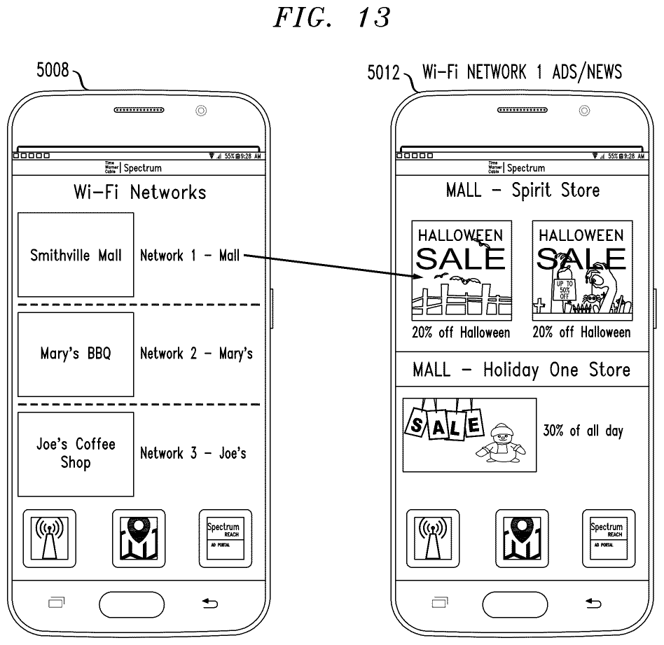

FIG. 10 illustrates a system 4000 including a client device 4024-1, such as a smartphone (e.g., using the iOS® operating system (registered mark of Cisco Technology, Inc., San Jose, CA, USA), the Android® operating system (registered mark of GOOGLE LLC Mountain View, CA, USA), or the like), configured to connect with Wi-Fi networks 4020-1, 4020-2, 4020-3, 4020-4, in accordance with example embodiments. Each Wi-Fi network 4020-1, 4020-2, 4020-3, 4020-4 includes a messaging portal (which can also be thought of as an engagement portal that facilitates messaging) 4028-1, 4028-2, 4028-3, 4028-4 that provides access by the client device 4024-1 to the corresponding Wi-Fi network 4020-1, 4020-2, 4020-3, 4020-4. Each messaging portal 4028-1, 4028-2, 4028-3, 4028-4 includes a public access interface 4032-1, 4032-2, 4032-3, 4032-4 and/or a private access interface 4036-1, 4036-2, 4036-3, 4036-4. The public access interface 4032-1, 4032-2, 4032-3, 4032-4 enables users to access the networking services of the Wi-Fi network 4020-1, 4020-2, 4020-3, 4020-4 (such as Internet access) and access to the messages and the like provided by the Wi-Fi system. The private access interface 4036-1, 4036-2, 4036-3, 4036-4 enables users (e.g., Wi-Fi network owners/administrators such as property owners who own/manage the Wi-Fi network(s) or third parties to whom they permit access) to create and distribute content via the services of the Wi-Fi network 4020-1, 4020-2, 4020-3, 4020-4. For example, referring to FIG. 13, discussed in greater detail below, the user (e.g., consumer) in view 5008 is near three available Wi-Fi networks, namely, the Smithville Mall, Mary's BBQ, and Joe's Coffee Shop. In this example, there is a popup as seen at 5012 for a specific network such as Network 1 Mall which shows one or more messages (in this case, in the form of deals). Previously, the owner of Network 1 used the messaging portal to place the messages (in the example, in the form of advertisements/deals) onto the server 4012. These placed messages propagate to the app on the user's (e.g., consumer's) phone and any user with appropriate access can see the messages (for public messages, anyone can see; for private messages, the user must be logged onto the Wi-Fi network of interest (here, “Mall)). In at least some instances, the owner/administrator of a Wi-Fi network or permitted third parties, have access to the portal to create or modify messages using a Management UI (not separately numbered in FIGS. 10 and 11) that enables (1) message creation and (2) message updating and also provides (3) a dashboard function. See, for example, discussion of the messaging portal interface 6017 below.

FIG. 11 illustrates a Wi-Fi system 5000, in accordance with example embodiments. The Wi-Fi system 5000 includes a mobile application for the client device 4024-1, a server infrastructure 4040, Wi-Fi networks 4020-1, 4020-2 and messaging portals 4028-1 and 4028-2. Note that only two Wi-Fi networks 4020-1, 4020-2 and two corresponding portals 4028-1, 4028-2 are shown in FIG. 11, but any desired number of Wi-Fi networks can be included as desired.

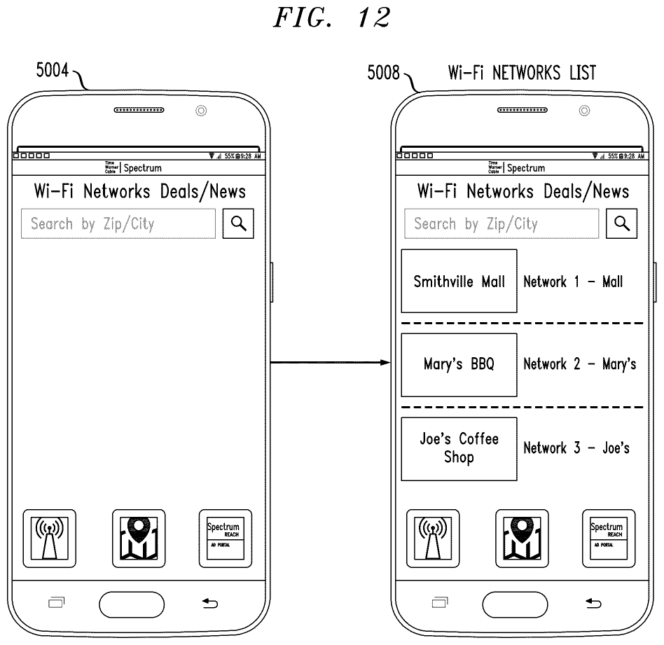

The mobile application for the client device 4024-1 allows users to access content via the Wi-Fi networks 4020-1, 4020-2, as described below in conjunction with FIGS. 12-15. Content may be accessed in a conventional manner via the Internet, may be accessed using the techniques disclosed herein, or both. The content may be accessed either before or after registering with the Wi-Fi network 4020-1, 4020-2. In one example embodiment, the client device 4024-1 may also access content of the content delivery network 4040 via the Internet mobile network 4004.

In one example embodiment, a feature-rich Wi-Fi mobile application (WMA) is configured for both network users and the general public. The WMA is an expanded WNF (Wi-Fi network finder) that serves as a convenient tool for users to discover nearby Wi-Fi networks 4020-1, 4020-2. Furthermore, users can explore a dedicated section within the WMA where they can find emergency notifications, messages from businesses and the like via the Wi-Fi networks 4020-1, 4020-2 that are discovered by and/or connected to the client device 4024-1. This creates an opportunity for businesses to reach their target audiences in a hyper-localized and contextually relevant manner. The WMA thus provides convenient Wi-Fi network discovery and connectivity. In one example embodiment, the messages and the like may be overlayed or incorporated into content being transported from the Internet to the client device 4024-1 via the Wi-Fi network 4020-1, 4020-2. Personalized recommendations can be based on user preferences in one or more embodiments. For example, if a user's (e.g., consumer's) device is recognized and it is known that such user purchased a product subject to recall, that user can receive safety alert message. Similarly, targeted advertisements can be provided. For example, suppose the owner of “Network 1—Mall” owns the entire Smithville Mall. Each store in the mall can have a specific Wi-Fi SSID. Messages are propagated into the network specific locations (i.e., with regard to the location of the user) are employed so that the user can find a store or an item in the store.

Geolocation-based targeting of messages based on the user's location in a given area or within the reach of specific Wi-fi Network 4020-1, 4020-2 can be based on location beacons, geofences, and the like. Geolocation/proximity features can be provided for identifying when the user of the client device 4024-1 is near a Wi-Fi network 4020-1, 4020-2 or other location in order to provide special messages. Some embodiments provide a social sharing and referral system. Some embodiments add the ability for users to see more interactive messages, such Augmented Reality (AR) or Virtual Reality (VR) messages.

In one or more embodiments, the Internet mobile network 4004 provides connectivity for the client device 4024-1 to access the Internet, the content delivery network 4040, and the like.

The Wi-Fi networks 4020-1, 4020-2 provide conventional network connectivity for the client device 4024-1, such as connectivity with the Internet. In addition, the Wi-Fi networks 4020-1, 4020-2 provide content, such as messages and the like, in accordance with the capabilities of the exemplary Wi-Fi system 5000.

The messaging portal 4028-1, 4028-2 enables users to create and distribute content, such as emergency notifications, advertisements and the like. The content is stored on the front-end server(s) 4008 and/or the backend server(s) 4012 of a content delivery network 4040. In one or more embodiments, the same portal can be used to create messages and to interface with message recipients. Through the messaging portals 4028-1, 4028-2, and corresponding client interfaces, owners and managers can easily create and manage messaging campaigns, specifying the target audience, duration, and display frequency. The owners and managers can leverage detailed analytics to evaluate the effectiveness of their campaigns, optimizing their strategies for maximum engagement and revenue generation.

The content delivery network 4040 stores content, such as emergency notifications, advertisements, and the like on the front-end server(s) 4008, the backend server(s) 4012, or both. The content delivery network 4040 also facilitates the creation, management and distribution of the content.

It is noted that beacon technology may be utilized in conjunction with the Wi-Fi networks 4020-1, 4020-2, such that the location of the client device 4024-1 can be used to target the distribution of content based on location, such as within a mall, near a given store, and the like. Further regarding beacon technology, if a user is logged onto a Wi-Fi network, and the owner wants you to enable the user to find a specific product, beacon technology can be used. Suppose a store has an offer for a bicycle, at 50% off. Place a beacon on the bicycle and connect to the Wi-Fi network through Bluetooth or the like to show a location of the specific item that is “on special.” For example, in a home center store, where a user is logged onto the home center store's Wi-Fi, the user passes a display of gardening tools, and a wheelbarrow that is on sale has a beacon and the beacon pings the user when the user gets within a predetermined distance such as 10 yards/9 meters.

The delivery of content via the client device 4024-1 may incorporate innovative techniques, including augmented reality (AR), interactive content and the like.

### User Profiles and Preferences

In one or more embodiments, user profiles and preferences are managed and leveraged to tailor content and engagement experiences. Wi-Fi network owners and managers can manage their content, such as messages, for distribution to either public users or users registered with the Wi-Fi networks 4020-1, 4020-2 using the features of the mobile application of the client device 4024-1 and the ability to identify whether the user is on the local Wi-Fi network 4020-1, 4020-2, on a mobile network 4004, and the like.

### Security and Privacy Measures

In one or more embodiments, rigorous security measures protect user data, ensuring compliance with privacy regulations. In one example embodiment, the security and privacy measures are implemented on the backend server(s) 4012 of the content delivery network 4040.

### Messaging Campaign Management

In one or more embodiments, the Wi-Fi system 5000 enables Wi-Fi network owners, managers, message originators, and the like to create, manage, and optimize messaging campaigns with precision by linking to the front-end server(s) 4008 and the backend server(s) 4012 of the content delivery network 4040. As described above, the messaging portals 4028-1, 4028-2 are used to create and manage messages. Users can access content on the messaging portal 4028-1, 4028-2 via the Wi-Fi networks 4020-1, 4020-2 or via the mobile network 4004.

### Data Analytics and Insights

In one or more embodiments, user data is collected and analyzed to enhance the targeting of messages and provide valuable insights to message originators.

### Interactive and Gamified Elements

In one or more embodiments, the Wi-Fi system 5000 incorporates interactive and gamified elements to boost user engagement and ad effectiveness. All interactive elements for the application are stored on the front-end server(s) 4008 to provide access to users through the mobile applications.

### Social Sharing Integration

In one or more embodiments, users can seamlessly share ad content on social media platforms, extending the reach of messaging campaigns from the Wi-Fi network 4020-1, 4020-2.

### Analytics and Reporting

In one or more embodiments, detailed analytics and reporting tools empower Wi-Fi network owners, managers and message originators to track messaging campaign performance.

### Operation and Use

Users, Wi-Fi owners and managers, and message originators can easily utilize the Wi-Fi system 5000 to create, manage, and experience engaging messaging campaigns.

It is worth noting that applications (“apps”) exist to identify Wi-Fi networks (such an app is known as a Wi-Fi Network Finder or WNF) for a user in a geographic area and that applications to manage Wi-Fi networks (i.e., in terms of who can have access) exist. In one or more embodiments, a messaging portal is implemented in a Centralized/Private server and is accessible by way of a Wi-Fi network, using, for example—Network ID/SSID verification.

FIG. 12 illustrates example screen shots 5004, 5008 of a GUI for viewing messages such as advertisements, deals, news and notifications on a client device 4024-1, in accordance with example embodiments. As illustrated in FIG. 12, a first GUI window 5004 enables a user to search for Wi-Fi networks 4020-1, 4020-2 by zip code and/or city, business name, network ID, business type, and the like. As illustrated in FIG. 12, a second GUI window 5008 results from entering the zip, city name, etc. and enables a user to view a selection of sources for the messages and notifications associated with a selected Wi-Fi network 4020-1, 4020-2. Searches may also be conducted based on the Wi-Fi network 4020-1, 4020-2, 4020-3, 4020-4, business and the like. In this exemplary case, the search results include Network 1 for the Smithville Mall, Network 2 for Mary's BBQ, and Network 3 for Joe's Coffee shop.

FIG. 13 illustrates example screen shots 5008, 5012 of a GUI for viewing advertisements, deals, news and notifications on a client device 4024-1, in accordance with example embodiments. Screen shot 5008 is the same as in FIG. 12. As illustrated in FIG. 13, a third GUI window 5012 enables a user to view the messages and notifications of a selected source displayed in the GUI window 5008. In this exemplary case, the user in screen 5008 selected Network 1 for the Smithville Mall, and the result is screen 5012 showing example messages for the Spirit Store and the Holiday One Store in the Smithville Mall. In addition to finding Wi-Fi network 4020-1, 4020-2; messages; and the details noted above, discount codes, social sharing options and the like may also be accessed.

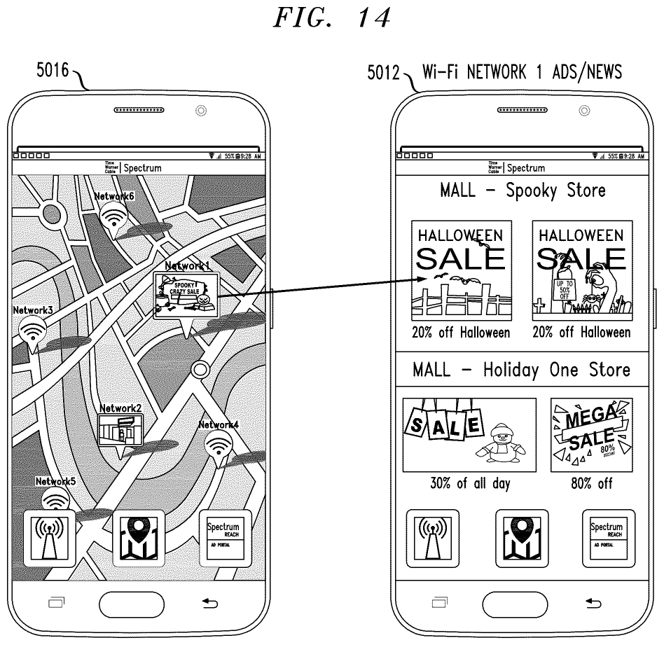

FIG. 14 illustrates screen shots 5016, 5012 of a GUI for viewing messages and notifications on a client device 4024-1, in accordance with example embodiments. Screen shot 5012 is the same as screen shot 5012 in FIG. 13 reached via a different route; namely, from screen shot 5016. Thus, as illustrated in FIG. 14, a fourth GUI window 5016 enables a user to search for Wi-Fi networks such as 4020-1, 4020-2, via a map interface. As illustrated in FIG. 14, as in FIG. 13, window 5012 enables a user to view the advertisements, deals, news and notifications associated with a selected Wi-Fi network 4020-1, 4020-2 (again, in this example, associated with Network 1 for the Smithville Mall).

Thus, by way of review, in FIG. 12, view 5004 shows an initial screen that allows a user to enter search criteria such as ZIP code, city, or the like. When the user enters the ZIP code, city, or the like, the result is screen 5008 showing three available networks within a certain radius. FIG. 13 repeats screen 5008, and the user decides that the user is interested in Network 1—Mall which brings up screen 5012. In an example, different shops in the mall can have different SSIDs. The network owners or others having administrative authority for the Wi-Fi networks can create different specials in each store and these specials pop out on the screen. FIG. 14 shows another option where view 5016 is a map and the user can see different networks. When the user selects Network 1 the user obtains screen 5012 again.

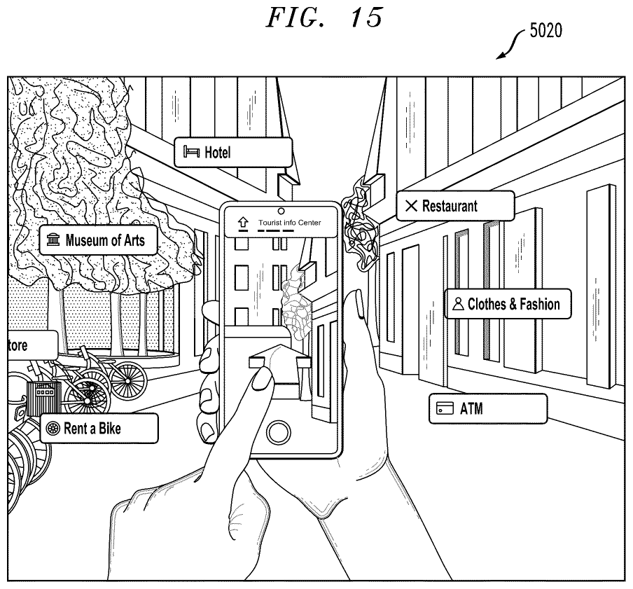

FIG. 15 illustrates an example GUI 5020 for using augmented reality in conjunction with the Wi-Fi system 5000, in accordance with example embodiments. Augmented (AR) or virtual (VR) reality advantageously provides different types of interactive modes for the messaging. In some instances, the location of a beacon could be reflected in the AR or VR. The skilled artisan will be familiar with known techniques to integrate AR and/or VR functionality into apps.

It will thus be appreciated that one or more embodiments provide a system for delivering interactive messaging content within Wi-Fi networks, including a mobile app, a Wi-Fi network messaging portal, server infrastructure, and user devices, as described. Furthermore, one or more embodiments provide a method for tailoring message content to user profiles and preferences within a Wi-Fi network by integrating a Wi-Fi messaging management portal in the Wi-Fi networks systems. Indeed, in one or more embodiments, by offering a comprehensive platform that improves user engagement, delivers individualized messaging content, and providing useful insights to message originators and Wi-Fi network owners, an exemplary system enhances Wi-Fi network communication. Indeed, one or more embodiments provide techniques which turn Wi-Fi networks into effective messaging platforms that would be advantageous to users, message originators, and Wi-Fi network owners alike.

One or more embodiments optionally also include mechanisms to gain insights into user behavior and campaign effectiveness.

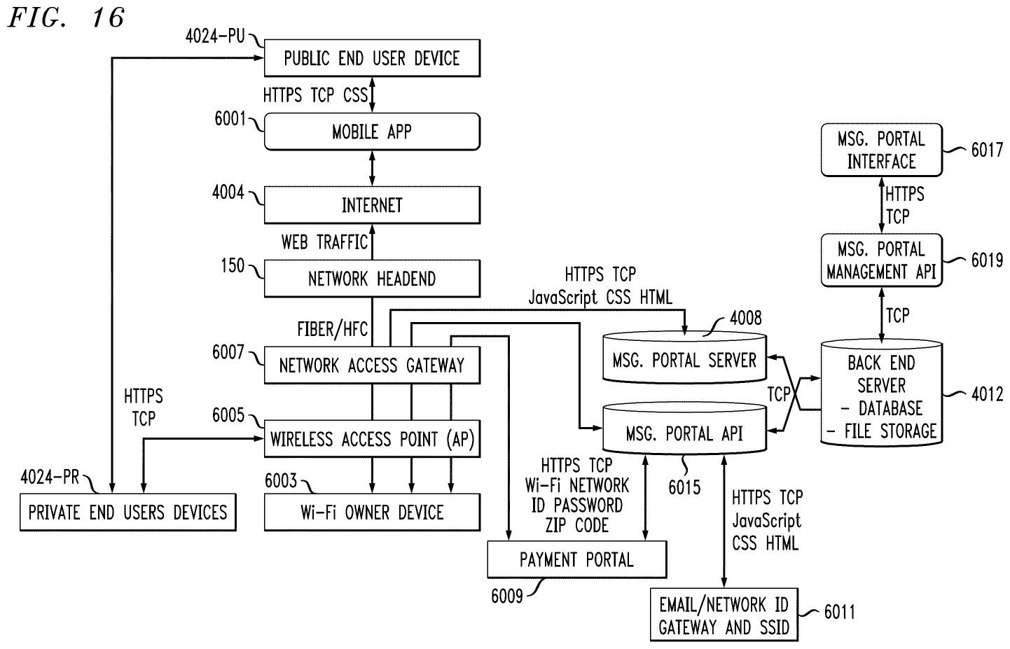

FIG. 16 shows additional connection details for a non-limiting exemplary embodiment. Note the connection from network head end 150 to the Wi-Fi owner's network including WAP 6005 via network access gateway 6007 using a fiber or HFC network. One or more back end servers 4012 can be included, to host a database that stores messages, user information, and the like, and can also, for example, facilitate user authorization and/or authentication, as well as file storage. In some instances, a user connects to the messaging portal server 4008 to create a message or to pull down data when connected using mobile app 6001 to view messages from Wi-Fi owners or their permitted third party message senders. In the former case the user is, for example, an owner of the Wi-Fi network using device 6003 while in the latter case the user is, for example, a consumer using public device 4024-PU or private device 4024-PR. Message portal API 6015 provide connectivity between the payment portal 6009 and the messaging portal so the user (e.g., entity placing the messages) can make payments. Note messaging portal interface 6017 which end users such as Wi-Fi owners or their permitted third party message senders see. Interface 6017 connects to database 4012 through messaging portal management API 6019. Block 6011 interacts with API 6015 to provide E-mail, network ID and SSID functionality. Non-limiting exemplary protocols and the like are indicated in FIG. 16 including Hypertext transfer protocol secure (HTTPS), Transmission Control Protocol (TCP), Cascading Style Sheets (CSS), JavaScript scripting language, and Hyper Text Markup Language (HTML), as will be familiar to the skilled artisan. Communications to the API 6015 and/or Payment Portal 6009 can also include, for example, the Wi-Fi network ID, password, and zip code.

The public end user device 4024-PU represents the mobile phone or other device of a consumer or the like who is not logged onto one of the Wi-Fi networks but is rather just in the area searching for Wi-Fi networks using 5G connectivity or the like. For example, this person may be searching for restaurants to see the specials. This person can connect via the mobile app 6001 and internet 4004 and pull down the relevant data as web traffic. In some cases, the content can be maintained by a provider of broadband wired or wireless network connectivity. The private end user device 4024-PR represents a mobile phone or other device of a private end user; i.e., one who is already connected to one of the Wi-Fi networks. It is possible for the Internet Service Provider (ISP) to identify this device as connected to the Wi-Fi network of interest using known techniques.

It is worth noting that the APP 6001 is depicted logically as a separate block but typically resides on the device 4024-PU or 4024-PR as the case may be.

The messaging portal, which as noted can also be thought of as an engagement system, can reside, for example, on the provider's server or the Wi-Fi network owners could maintain same in their own networks with connectivity up to the provider, or some mixture of the approaches could be employed.

Consider now an exemplary sequence of steps to implement one or more embodiments. While browser-based implementations are possible, this example is in the context of an app-based solution using app 6001. One step is making the app 6001 available from an “app store” or other web site or the like in a known manner. APP 6001 runs on a phone connected to 5G or a similar wireless network. Public end user uses device 4024-PU and is attracted to a sporting goods store because they are having a sale on tennis shoes. Public end user connects to the sporting goods stores Wi-Fi network thus becoming a private user and the user's device becomes a private device 4024-PR. The connection to the store's Wi-Fi provides various messages such as advertisements and a buy one get one free coupon. This coupon could be customized; for example, a registered ID of the phone could be recognized and a query can be run in the database of the back end server 4012 to retrieve the consumer's demographic information. Based on personal and demographic information it can be determined that the consumer is a senior citizen who enjoys playing tennis and the consumer can be offered a “deal” on tennis shoes in a style popular with people in the senior citizen demographic. In one or more embodiments, there can be “public” specials and additional “private” specials. A general sale on tennis shoes could be publicly advertised over 5G or the like and once the individual connects to Wi-Fi, a tailored offer is provided. Generally, when it is desired to know how to customize a message or to determine what network has a “deal” or the like, run queries in the database of back end server 4012 based on network id and user id or other relevant query terms.

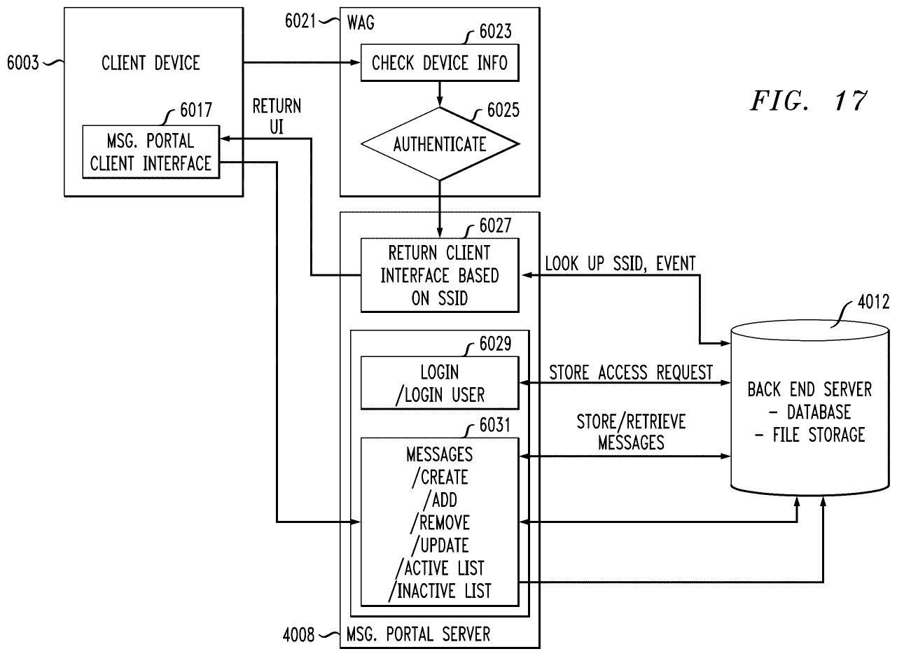

FIG. 17 shows an exemplary deeper breakdown of the messaging portal server 4008, which connects to back end server 4012. Consider an owner/administrator of a Wi-Fi network, or an advertiser or other third party that the owner/administrator wants to allow to create messages. Client device 6003 belongs, for example, to the owner of a Wi-Fi network who is already registered on that network. Wireless Access Gateway (WAG) 6021 provides a main gateway before the Wi-Fi network connects to the provider's network. The owner is authenticated to the Wi-Fi network and then can create, add, remove, or update messages; add messages to the active list; or remove them from the list, using interface 6017, as seen at 6031. After authentication, server 4008 returns the UI back to the user device 6003. The changes made to the messages by the owner are propagated to the back end server 4012, and can then be accessed by the users/consumers.

Specifically, in WAG 6021, the information regarding the client device 6003 is checked at 6023, and if successful, the owner is authenticated at 6025. If either aspect fails, access is denied. If successful, the client user interface 6015 enabling the client to make changes is returned at 6027, based, for example, on the SSID which can be looked up in a database on server 4012. The owner is permitted to make changes such as storing, retrieving, or modifying messages after successful login as shown at 6029. Access requests can be stored.

It is worth noting that the skilled artisan will understand from the context whether a client device belongs to a consumer/end user at 4024-PU or 4024-PR, or to the Wi-Fi owner/administrator at 6003.

As noted above, in one or more embodiments, the same portal can be used to create messages and to interface with message recipients. However, the portal functionality can be logically or physically separated for various tasks. For example, access by end users/consumers can be handled differently or using different components than access by Wi-Fi owners, administrators, or their permitted third parties, as will be appreciated by reference to the various examples in the figures.

Given the discussion thus far, it will be appreciated that, in general terms, an exemplary method, according to an aspect of the invention, includes the step of making available, to a plurality of administrators (which could be, e.g., the owners themselves or individuals they authorize) of a plurality of wireless local area networks 4020-1, 4020-2, 4020-3, 4020-4, a portal that permits specification of messages to be displayed to potential users of the wireless local area networks. Refer, for example, to the discussion of elements 4028-1, 4028-2, 4028-3, 4028-4, the front end server 4008, and the back-end server 4012. A further step includes obtaining, by a wide area network operator (e.g., internet service provider that could provide the HFC or optical network and/or the internet mobile network), via the portal, a plurality of messages associated with the plurality of wireless local area networks, to be provided to putative users of the plurality of wireless local area networks. Still a further step includes selectively providing (i.e., by the wide area network operator) at least a subset of the plurality of messages to corresponding ones of the putative users (e.g., to device(s) 4024-1, 4024-PR, 4024-PU).

A variety of messages can be supported, such as a simple image, a brief video, or more complicated/interactive content. Metadata can be used to specify for how long a message is to be displayed.

As noted, the portal can be referred to as a messaging portal (which can also be thought of as an engagement portal that facilitates messaging). The portal can be hosted, for example, on a centralized server, which can be private or part of a cloud-based platform.

Putative users can, for example, obtain messages over wireless internet for several Wi-Fi networks (generally, wireless LANs) the users are near or can obtain messages for a particular Wi-Fi network or other wireless LAN to which they are connected. In some instances, an exemplary system can identify users already related to a given wireless LAN based on information in the database of server 4012. If a putative user is outside the network, and just searching for local Wi-Fi networks, the user will just see messages that are open to the public.

Thus, in some instances, the step of selectively providing at least the subset of the plurality of messages includes providing the subset via broadband wireless internet 4004 based on user proximity to a subset of the plurality of wireless local area networks (e.g., messages are provided over 5G when the phone user is near networks 1-3 in FIG. 13).

In some instances, the portal permits specification of the messages as public messages or private messages. For example, they can be flagged in the database of server 4012 when uploaded. In some instances, only the public messages are provided over the broadband wireless internet.

On the other hand, in some cases, the step of selectively providing at least the subset of the plurality of messages includes providing at least one of the plurality of messages associated with one of the plurality of wireless local area networks to which a device of the user is connected, using the one of the plurality of wireless local area networks to which the device of the user is connected. In some instances, at least the private messages are provided over the one of the plurality of wireless local area networks to which the device of the user is connected.

Referring to the discussions of beacon technology, in some instances, at least one of the private messages is based on proximity of a corresponding one of the putative users who has logged onto one of the wireless local area networks to a beacon coupled to the one of the wireless local area networks.

Referring, for example, to FIGS. 13 and 14 and accompanying text, in some cases, at least one of the messages is provided responsive to a selection from one of the putative users.

One or more embodiments further include making an application 6001 available to the putative users; the messages are provided via the application. However, as noted, messages can additionally or alternatively be provided via browsers of user devices.

The step of making the portal available can further include making the portal available to permitted third parties. The plurality of messages can include at least some messages from the permitted third parties (e.g., owner of sporting goods store accepts messages from manufacturer of football helmet that is subject to a safety recall). The “portal” could include multiple portals for owners/administrators and third parties, together still forming a single overall portal.

In one or more embodiments, making the portal available includes exposing an application programming interface that provides access to a database (e.g., on server 4012) of the portal on which the messages are stored, and the step of selectively providing at least the subset of the plurality of messages includes serving out the messages from the database. See, e.g., the discussion of APIs with regard to FIG. 16.

One or more embodiments further include populating the database with demographic information pertaining to at least some of the putative users; at least some of the messages are then based on the demographic information. Refer, e.g., to the tennis shoe example.

In another aspect, a non-transitory computer readable medium including computer executable instructions which when executed by a computer cause the computer to perform a method including any one, some, or mall of the method steps set forth herein

In still another aspect, an exemplary messaging portal, which can also be thought of as an engagement portal that facilitates messaging, includes a memory such as 730 discussed elsewhere herein, and at least one processor, such as 720 discussed elsewhere herein, which is coupled to the memory, and operative to carry out or otherwise facilitate any one, some, or all of the method steps herein. For example, the at least one processor is operative to make available, to a plurality of administrators of a plurality of wireless local area networks, access to the portal to permit specification of messages to be displayed to potential users of the wireless local area networks; obtain, by a wide area network operator, via the portal, a plurality of messages associated with the plurality of wireless local area networks, to be provided to putative users of the plurality of wireless local area networks; and selectively provide at least a subset of the plurality of messages to corresponding ones of the putative users.

One or more embodiments further include an interface from the at least one processor to a broadband wireless internet 4004 (e.g., via a back end of an operator of a network such as network 1000); the selective provision of at least the subset of the plurality of messages then includes providing the subset via broadband wireless internet, using the interface, based on user proximity to a subset of the plurality of wireless local area networks.

As noted, the portal can permit specification of the messages as public messages or private messages, and in some cases, only the public messages are provided over the broadband wireless internet; in some cases, at least the private messages are provided over the one of the plurality of wireless local area networks to which the device of the user is connected.

One or more embodiments further include an interface from the at least one processor to a broadband wired network (e.g., HFC or fiber network as discussed above); the selective provision of at least the subset of the plurality of messages then includes providing at least one of the plurality of messages associated with one of the plurality of wireless local area networks to which a device of the user is connected, by dispatching the at least one of the plurality of messages to the one of the plurality of wireless local area networks to which the device of the user is connected over the broadband wired network. For example, the wireless LAN uses a device such as element 106 in FIG. 5 which obtains messages over the HFC or fiber network and makes then wirelessly available to devices connected to the wireless LAN.

In some cases, at least one of the private messages is based on the wide area network operator obtaining an indication of proximity of a corresponding one of the putative users who has logged onto one of the wireless local area networks to a beacon coupled to the one of the wireless local area networks. For example, the beacon is coupled to a local element such as element 106 in FIG. 5 and messages indicating user proximity are obtained over the HFC or fiber network.

Referring to FIGS. 13 and 14, in some instances, at least one of the messages is provided responsive to the wide area network operator obtaining a selection from one of the putative users. For example, the user makes the selection using a phone touch screen and the wide area network operator obtains the selection via a cellular network.

As noted, some embodiments further include the wide area network operator making an application 6001 available to the putative users (e.g., from an “app server” that serves the application code out over the cellular network), and the messages are provided via the application.

One or more embodiments further include an application programming interface (6015 and/or 6019) and a database (e.g., hosted on server 4012) associated with the at least one processor; making the portal available then includes exposing the application programming interface to provide access to the database. The messages are stored on the database, and the selective provision of at least the subset of the plurality of messages includes serving out the messages from the database. The database can be populated with demographic information pertaining to at least some of the putative users, and at least some of the messages can be based on the demographic information.

In another aspect, another exemplary messaging portal, which can also be thought of as an engagement portal that facilitates messaging, includes at least one server hosting a database (for example, servers 4008 and 4012 with the database hosted on server 4012). The portal further includes at least one application programming interface, and at least one network interface coupled to the at least one server. The at least one application programming interface provides a plurality of administrators of a plurality of wireless local area networks access to the database to permit specification of messages to be loaded into the database for display to potential users of the wireless local area networks. For example, see APIs 6015 and 6019. The database stores the plurality of messages, and the at least one server selectively provides at least a subset of the plurality of messages to corresponding ones of the putative users via the network interface (e.g., broadband wired (HFC, fiber) or wireless (cellular) networks as discussed elsewhere herein). The various optional features of the exemplary messaging portal including the memory and the at least one processor are equally applicable to the exemplary portal discussed in this paragraph and including the at least one server.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

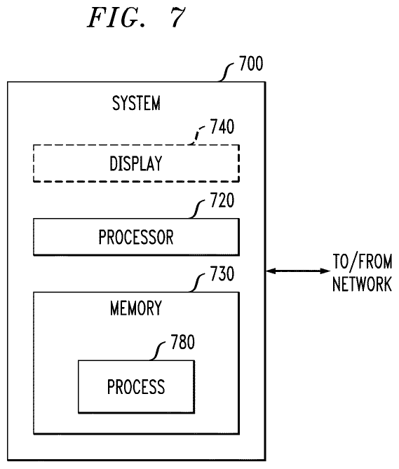

FIG. 7 is a block diagram of at least a portion of an exemplary system 700 that can be configured to implement at least some aspects of the invention, and is representative, for example, of one or more of the apparatuses, servers, or modules shown in the figures, including user devices. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

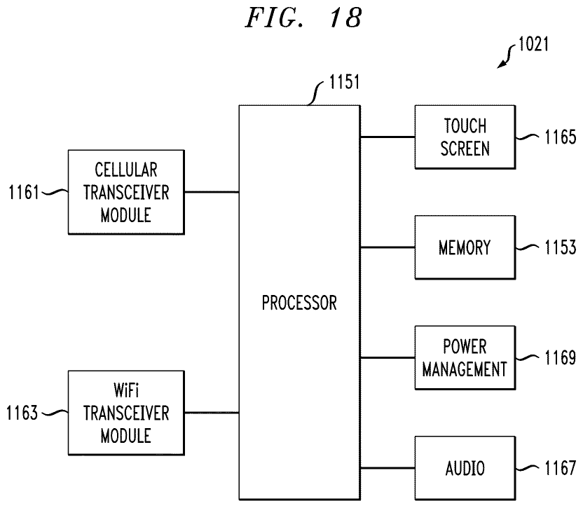

FIG. 18 shows another exemplary configuration of a mobile device 1021 such as a mobile phone, cellular-enabled tablet, or cellular-enabled laptop. Device 1021 includes a suitable processor; e.g., a microprocessor 1151. A cellular transceiver module 1161 coupled to processor 1151 includes an antenna and appropriate circuitry to send and receive cellular telephone signals, e.g., 3G, 4G, or 5G. A Wi-Fi transceiver module 1163 coupled to processor 1151 includes an antenna and appropriate circuitry to allow phone 1021 to connect to the Internet via a wireless network access point or hotspot.

In one or more embodiments, one or more applications in memory 1153, including app 6001, when loaded into RAM or other memory accessible to the processor cause the processor 1151 to implement aspects of the functionality described herein.

Touch screen 1165 coupled to processor 1151 is also generally indicative of a variety of I/O devices, all of which may or may not be present in one or more embodiments. Memory 1153 is coupled to processor 1151. Audio module 1167 coupled to processor 1151 includes, for example, an audio coder/decoder (codec), speaker, headphone jack, microphone, and so on. Power management system 1169 can include a battery charger, an interface to a battery, and so on.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
making available, to a plurality of administrators of a plurality of wireless local area networks, a portal that permits specification of messages to be displayed to potential users of the wireless local area networks;
obtaining, by a wide area network operator, via the portal, a plurality of messages associated with the plurality of wireless local area networks, to be provided to putative users of the plurality of wireless local area networks; and
selectively providing at least a subset of the plurality of messages to corresponding ones of the putative users.

2. The method of claim 1, wherein the step of selectively providing at least the subset of the plurality of messages comprises providing the subset via broadband wireless internet based on user proximity to a subset of the plurality of wireless local area networks.

3. The method of claim 2, wherein the portal permits specification of the messages as public messages or private messages, and wherein only the public messages are provided over the broadband wireless internet.

4. The method of claim 1, wherein the step of selectively providing at least the subset of the plurality of messages comprises providing at least one of the plurality of messages associated with one of the plurality of wireless local area networks to which a device of the user is connected, using the one of the plurality of wireless local area networks to which the device of the user is connected.

5. The method of claim 4, wherein the portal permits specification of the messages as public messages or private messages, and wherein at least the private messages are provided over the one of the plurality of wireless local area networks to which the device of the user is connected.

6. The method of claim 5, wherein at least one of the private messages is based on proximity of a corresponding one of the putative users who has logged onto one of the wireless local area networks to a beacon coupled to the one of the wireless local area networks.

7. The method of claim 1, wherein at least one of the messages is provided responsive to a selection from one of the putative users.

8. The method of claim 1, further comprising making an application available to the putative users, wherein the messages are provided via the application.

9. The method of claim 1, wherein the messages are provided via browsers of user devices.

10. The method of claim 1, wherein the making available further includes making the portal available to permitted third parties, and wherein the plurality of messages include at least some messages from the permitted third parties.

11. The method of claim 1, wherein making the portal available comprises exposing an application programming interface that provides access to a database of the portal on which the messages are stored, and wherein the step of selectively providing at least the subset of the plurality of messages comprises serving out the messages from the database.

12. The method of claim 11, further comprising populating the database with demographic information pertaining to at least some of the putative users, wherein at least some of the messages are based on the demographic information.

13. A non-transitory computer readable medium comprising computer executable instructions which when executed by a computer cause the computer to perform a method comprising:
making available, to a plurality of administrators of a plurality of wireless local area networks, a portal that permits specification of messages to be displayed to potential users of the wireless local area networks;
obtaining, by a wide area network operator, via the portal, a plurality of messages associated with the plurality of wireless local area networks, to be provided to putative users of the plurality of wireless local area networks; and
selectively providing at least a subset of the plurality of messages to corresponding ones of the putative users.

14. A messaging portal comprising:
a memory; and
at least one processor, coupled to the memory, and operative to:
make available, to a plurality of administrators of a plurality of wireless local area networks, access to the portal to permit specification of messages to be displayed to potential users of the wireless local area networks;
obtain, by a wide area network operator, via the portal, a plurality of messages associated with the plurality of wireless local area networks, to be provided to putative users of the plurality of wireless local area networks; and
selectively provide at least a subset of the plurality of messages to corresponding ones of the putative users.

15. The messaging portal of claim 14, further comprising an interface from the at least one processor to a broadband wireless internet, wherein the selective provision of at least the subset of the plurality of messages comprises providing the subset via broadband wireless internet, using the interface, based on user proximity to a subset of the plurality of wireless local area networks.

16. The messaging portal of claim 15, wherein the portal permits specification of the messages as public messages or private messages, and wherein only the public messages are provided over the broadband wireless internet.

17. The messaging portal of claim 14, further comprising an interface from the at least one processor to a broadband wired network, wherein the selective provision of at least the subset of the plurality of messages comprises providing at least one of the plurality of messages associated with one of the plurality of wireless local area networks to which a device of the user is connected, by dispatching the at least one of the plurality of messages to the one of the plurality of wireless local area networks to which the device of the user is connected over the broadband wired network.

18. The messaging portal of claim 17, wherein the portal permits specification of the messages as public messages or private messages, and wherein at least the private messages are provided over the one of the plurality of wireless local area networks to which the device of the user is connected.

19. The messaging portal of claim 18, wherein at least one of the private messages is based on the wide area network operator obtaining an indication of proximity of a corresponding one of the putative users who has logged onto one of the wireless local area networks to a beacon coupled to the one of the wireless local area networks.

20. The messaging portal of claim 14, wherein at least one of the messages is provided responsive to the wide area network operator obtaining a selection from one of the putative users.

21. The messaging portal of claim 14, further comprising the wide area network operator obtaining making an application available to the putative users, wherein the messages are provided via the application.

22. The messaging portal of claim 14, wherein the messages are provided via browsers of user devices.

23. The messaging portal of claim 14, wherein the making available further includes making the portal available to permitted third parties, and wherein the plurality of messages include at least some messages from the permitted third parties.

24. The messaging portal of claim 14, further comprising an application programming interface and a database associated with the at least one processor, wherein making the portal available comprises exposing the application programming interface to provide access to the database, the messages being stored on the database, and wherein the selective provision of at least the subset of the plurality of messages comprises serving out the messages from the database.

25. The messaging portal of claim 24, wherein the database is populated with demographic information pertaining to at least some of the putative users, and wherein at least some of the messages are based on the demographic information.

26. A messaging portal comprising:
at least one server hosting a database;
at least one application programming interface; and
at least one network interface coupled to the server;
wherein:
the at least one application programming interface provides a plurality of administrators of a plurality of wireless local area networks access to the database to permit specification of messages to be loaded into the database for display to potential users of the wireless local area networks;
the database stores the plurality of messages; and
the at least one server selectively provides at least a subset of the plurality of messages to corresponding ones of the putative users via the network interface.
